(19) United States
(12) Patent Application Publication
(10) Pub. No.: US 2012/0278353 A1
(43) Pub. Date: Nov. 1, 2012

(54) SEARCHING WITH TOPIC MAPS OF A MODEL FOR CANONICAL MODEL BASED INTEGRATION

(75) Inventors: Anthony L. Carrato, New Milford, CT (US); Peter A. Coldicott, Jonestown, TX (US); Eoin Lane, Littleton, MA (US)

(73) Assignee: INTERNATIONAL BUSINESS MACHINES, Armonk, NY (US)

(21) Appl. No.: 13/096,322

(22) Filed: Apr. 28, 2011

(51) Int. Cl. G06F 17/30

(52) U.S. Cl. 707/769; 707/E17.014

(57) ABSTRACT

Receiving a search query from a user including a domain, a topic, a scope and a radix. Searching within a topic map based index of a topic map meta-model with instance ontology using as search parameters, the domain, the topic, the scope, and the radix of the search query. Displaying, for a user, results from the topic map meta-model with instance ontology which satisfy all of the search parameters of the search query.

### TECHNICAL FIELD

The present invention relates to searching topic maps of a model and more specifically to searching topic maps of a model for canonical model based integration.

### BACKGROUND

Models provide users with a way to understand interaction of different assets. Models are becoming increasingly complex. Simple searches of complex models are carried out using simple key word searches of a topic, and more complex searches are carried out using a query language such as SPARQL Protocol and RDF Query Language (SPARQL). SPARQL requires query language training that is generally applicable only to IT professionals.

### SUMMARY

According to one embodiment of the present invention, a method of searching within a topic map based index of a topic map meta-model with instance ontology. The method comprises the steps of: a computer receiving a search query from a user, the search query comprising a domain, a topic, a scope, and a radix; a computer searching the topic map based index of the topic map meta-model with instance ontology using as search parameters the domain, the topic, the scope, and the radix of the search query; and the computer displaying results from the topic map meta-model with instance ontology which satisfy all of the search parameters of the search query.

According to another embodiment of the present invention, a computer program product for searching within a topic map meta-model with instance ontology. The computer program product comprises one or more computer-readable tangible storage devices; program instructions, stored on at least one of the one or more storage devices, to receive a search query from a user, the search query comprising a domain, a topic, a scope, and a radix; program instructions, stored on at least one of the one or more storage devices, to search the topic map based index of the topic map meta-model with instance ontology using as search parameters the domain, the topic, the scope, and the radix of the search query; and program instructions stored on at least one of the one or more storage devices, to display results from the topic map meta-model with instance ontology which satisfy all of the search parameters of the search query.

According to another embodiment of the present invention, a computer system for searching within a topic map meta-model with instance ontology. The computer system comprises one or more computer-readable tangible storage devices, one or more processors, and one or more computer-readable memories; program instructions, stored on at least one of the one or more storage devices for execution by at least one of the one or more processors via at least one of the one or more memories, to receive a search query from a user, the search query comprising a domain, a topic, a scope, and a radix; program instructions, stored on at least one of the one or more storage devices for execution by at least one of the one or more processors via at least one of the one or more memories, to search the topic map based index of the topic map meta-model with instance ontology using as search parameters the domain, the topic, the scope, and the radix of the search query; and program instructions, stored on at least one of the one or more storage devices for execution by at least one of the one or more processors via at least one of the one or more memories, to display results from the topic map meta-model with instance ontology which satisfy all of the search parameters of the search query.

### BRIEF DESCRIPTION OF THE SEVERAL VIEWS OF THE DRAWINGS

FIG. 1 depicts a pictorial representation of a network of computers in which illustrative embodiments may be implemented.

FIG. 2 shows an example of an industry model repository (IMR) architecture system including a service oriented architecture (SOA) IMR component.

FIG. 3 shows an example of SOA IMR component 102 from FIG. 2 in greater detail

FIG. 4 shows a flowchart of a method for creating and searching a topic map meta-model with instance ontology.

FIG. 5 shows a flowchart of a method for searching a topic map meta-model with instance ontology with a search query.

FIG. 6 shows an examplary abstract model for work equipment used by city operations.

FIG. 7 shows a topic map meta-model with instance ontology of a portion of the abstract model of FIG. 6.

FIG. 8 shows an example of search results displayed to a user based on a search query of the topic map meta-model with instance ontology of FIG. 7.

FIG. 9 shows a topic map meta-model with instance ontology of a portion of the London Underground system.

FIG. 10 illustrates internal and external components of a client computer and a server computer in which illustrative embodiments may be implemented.

### DETAILED DESCRIPTION

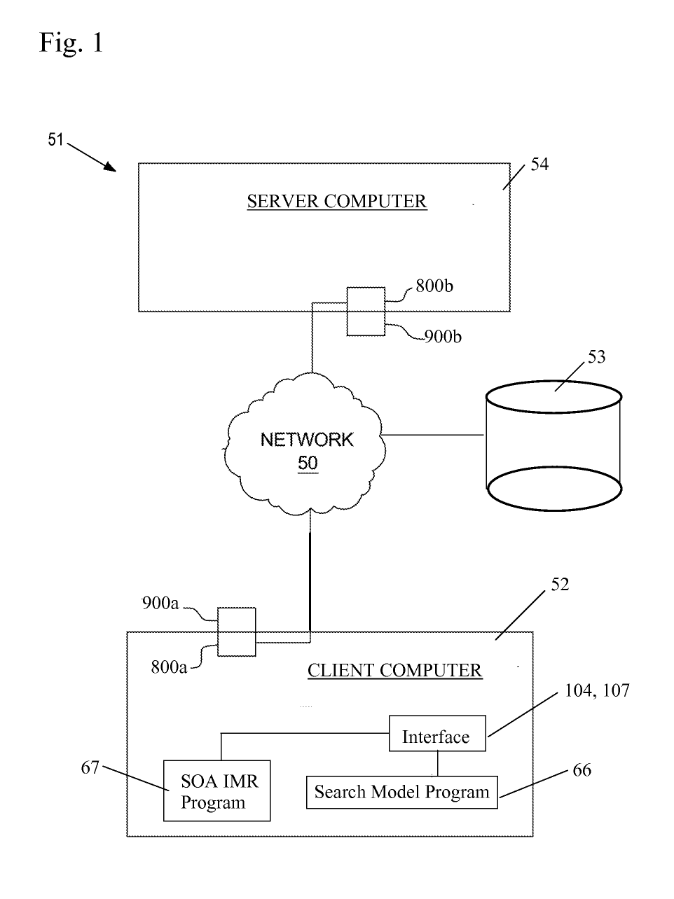

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

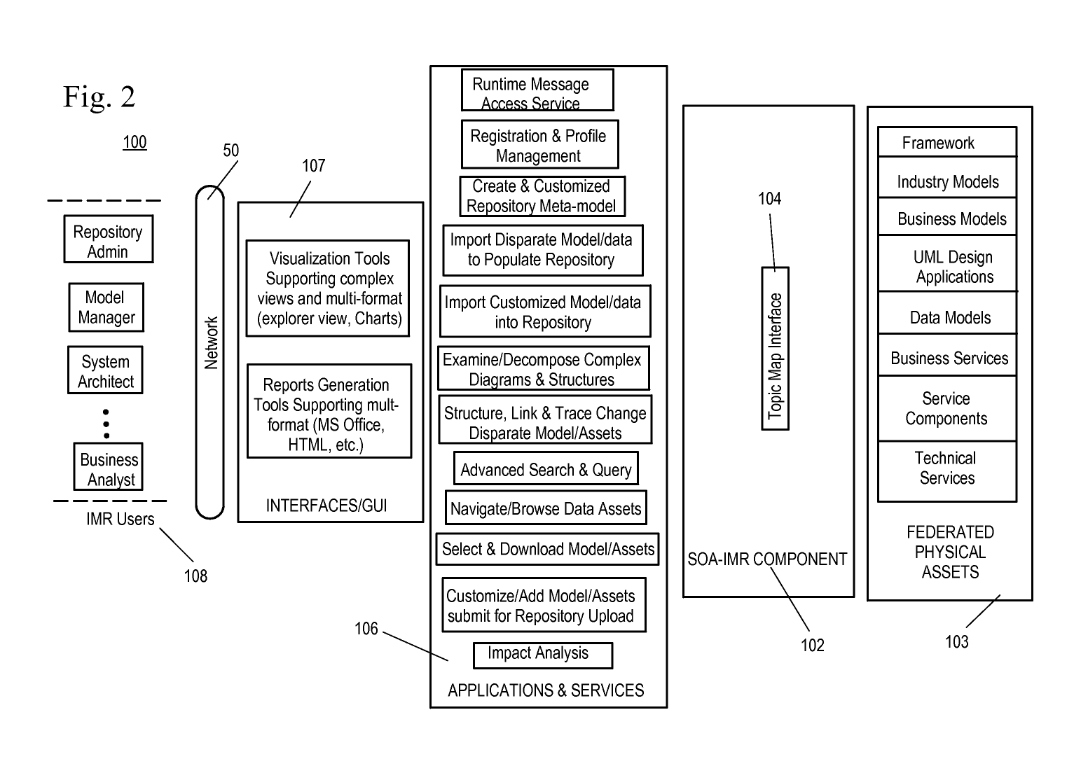

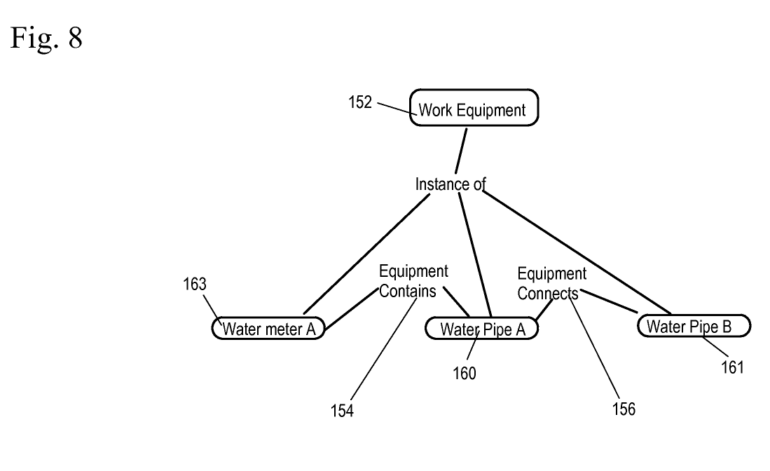

In the depicted example, client computer 52, tangible storage device 53, and server computer 54 connect to network 50. In other exemplary embodiments, network data processing system 51 may include additional client computers, storage devices, server computers, and other devices not shown. Client computer 52 includes a set of internal components 800a and a set of external components 900a, further illustrated in FIG. 8. Client computer 52 may be, for example, a mobile device, a cell phone, a personal digital assistant, a netbook, a laptop computer, a tablet computer, a desktop computer, or any other type of computing device. Client computer 52 may contain a topic map interface 104 and/or other interfaces 107. Through topic map interface 104, searches of topic maps may be performed and results of the searches may be displayed. Topic map interface 104 may accept commands and data entry from a user 108 as shown in FIG. 2. Topic map interface 104 can be, for example, a command line interface, a graphical user interface (GUI), or a web user interface (WUI) through which a user can access a search model program 66 on either client computer 52 or server computer 54. Server computer 54 includes a set of internal components 800b and a set of external components 900b illustrated in FIG. 8.

In the depicted example, server computer 54 provides information, such as boot files, operating system images, and applications to a client computer 52. Server computer 54 can compute the information locally or extract the information from other computers on network 50.

Program code, meta-models, a service oriented architecture (SOA) industry model repository (IMR) component 102, and programs such as search model program 66 and SOA IMR program 67 may also be located in network data processing system 51 and may be stored on at least one of one or more computer-readable tangible storage devices 830 shown in FIG. 8, on at least one of one or more portable computer-readable tangible storage devices 936 as shown in FIG. 8, on tangible storage device 53 connected to network 50, or downloaded to a data processing system or other device for use. For example, program code, meta-models, SOA IMR component 102, and programs such as search model program 66 and SOA IMR program 67 may be stored on at least one of one or more tangible storage devices 830 on server computer 54 and downloaded to client computer 52 over network 50 for use on client computer 52. Alternatively, server computer 54 can be a web server, and the program code, meta-models, SOA IMR component 102, and programs such as search model program 66 and SOA IMR program 67 may be stored on at least one of the one or more tangible storage devices 830 on server computer 54 and accessed on client computer 52. Search model program 66 can be accessed on client computer 52 through topic map interface 104. In other exemplary embodiments, the program code, meta-models, SOA IMR component 102, and programs such as search model program 66 and SOA IMR program 67 may be stored on at least one of one or more computer-readable tangible storage devices 830 on client computer 52 or distributed between two or more servers.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

FIG. 2 shows an example of an IMR architecture system 100 including SOA IMR component 102. IMR architecture system 100 may be part of the network data processing system 51 shown in FIG. 1. SOA IMR component 102 provides tools to facilitate the consumption and reuse of model assets through topic map IMR meta-model creation and topic map interface 104. SOA IMR component 102 is discussed in further detail in an application entitled, “SERVICE ORIENTED ARCHITECTURE INDUSTRY MODEL REPOSITORY META-MODEL WITH A STANDARD BASED INDEX” filed Dec. 17, 2009 as application Ser. No. 12/640,624. Through topic map interface 104, searches of topic maps may be carried out as discussed in further detail below.

IMR architecture system 100 includes federated physical model assets 103 that are stored in different types of repositories depending on the model driven framework tools and products that IMR architecture system 100 deploys. Federated physical model assets 103 may include framework, industry models, business models, unified modeling language (UML) design applications, data models, business services, service components, and technical services. Federated physical model assets 103 are not limited to the assets shown in FIG. 2.

Applications and services 106 are provided to IMR users 108 through network 50, using interfaces 107. Interfaces 107 may be a graphically enabled, allowing display of topics maps to IMR users 108. Interfaces 107 include reports generation and tools supporting multi-formats and visualization tools supporting complex views. Interfaces 107 may be packaged as an Eclipse client, provided by a vendor specialized in providing software development tools and products or deployed inside bigger scope modeling tools, for example IBM® Rational® Software Architect or WebSphere® Business Modeler, products of International Business Machines Corporation.

Applications and services 106 may include registration and profile management; creating and customizing repository meta-model; importing customized and disparate model/data into the repository; examining/decomposing complex diagrams and structures; structure, link, and trace change disparate model/assets; advanced search and query, navigate/browse data assets; select and download model/assets; customize/add models/assets submit for repository upload; and impact analysis. Applications and services 106 are not limited to the assets shown in FIG. 2. Applications and services 106 are described in greater detail in applications entitled, “FRAMEWORK TO POPULATE AND MAINTAIN A SERVICE ORIENTED ARCHITECTURE INDUSTRY MODEL” filed Dec. 17, 2009 as application Ser. No. 12/640,749; “MANAGING AND MAINTAINING SCOPE IN A SERVICE ORIENTED ARCHITECTURE INDUSTRY MODEL REPOSITORY” filed Dec. 17, 2009 as application Ser. No. 12/640,852; and “RECOGNITION OF AND SUPPORT FOR MULTIPLE VERSIONS OF AN ENTERPRISE CANONICAL MESSAGE MODEL” filed Dec. 17, 2009 as application Ser. No. 12/640,865. Interfaces 107 are further described in greater detail in an application entitled, “SERVICE ORIENTED ARCHITECTURE INDUSTRY MODEL REPOSITORY META-MODEL WITH A STANDARD BASED INDEX” filed Dec. 17, 2009 as application Ser. No. 12/640,624.

IMR users 108 may include but are not limited to a repository administrator, a model manager, a system architect, and a business analyst.

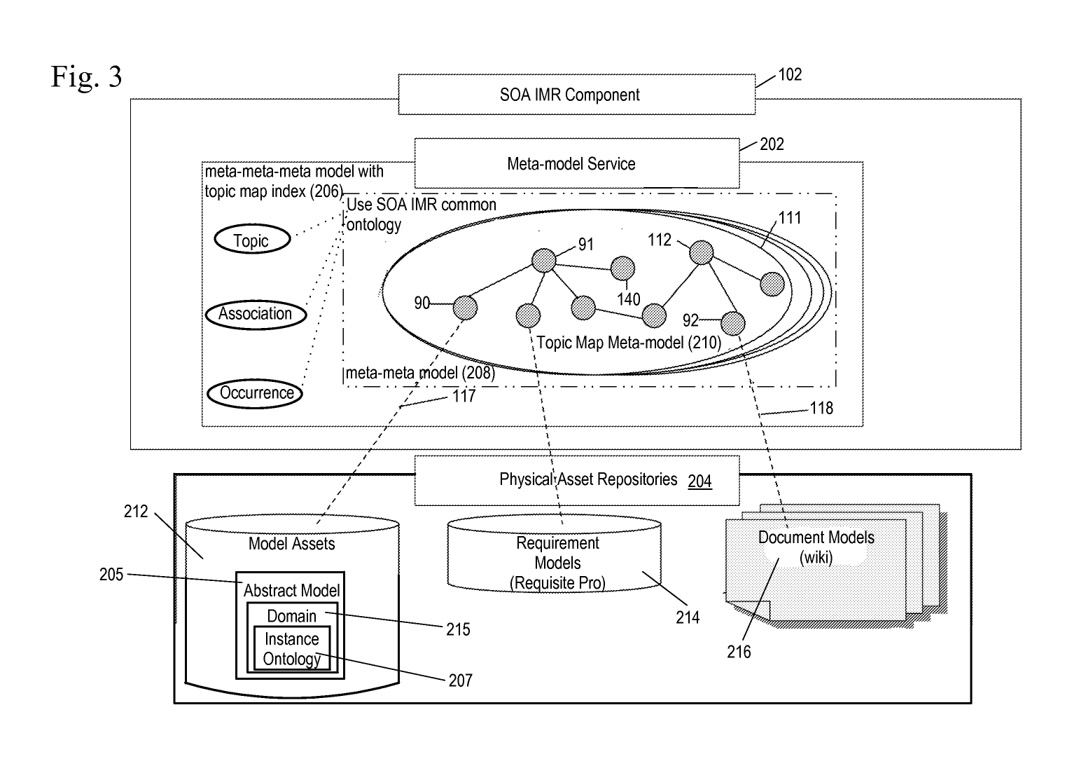

FIG. 3 shows an example of SOA IMR component 102 from FIG. 2 in greater detail. SOA IMR component 102 includes a Meta-Model Service interface to a Meta-Model Service 202. Meta-model service 202 is associated with physical asset repositories 204. Within Meta-Model Service 202 is a meta-meta-meta model 206 with a topic map based index, an IMR common meta-meta model 208 and at least one topic map meta-model 210 with data specific to an industry vertical. Topic map meta-model 210 is associated with physical asset repositories 204 of model assets 212, requirement models 214, and document models (wiki) 216. By using topic map meta-model 210 associated with model assets 212 that includes an abstract model 205 with instance ontology 207, based off of meta-meta-meta model 206 with the topic map based index, meta-meta model 208 with SOA IMR common ontology, a topic map meta-model can be created with instance ontology that incorporates topic map indexing of instance ontology.

Within model assets 212 is abstract model 205, which can be a canonical model such as Rational Software Modeler (RSM). Within abstract model 205 is a domain 215 with its own instance ontology 207. Instance ontology 207 is equivalent to a meta-model for each domain. Instance ontology 207 can also be referred to as instance data. An example of domain 215 is water, and an example of instance ontology 207 is the pipes associated with the water.

The cloud or topic map 111 has topics (shown as circles), which topics may be any of the meta-models present in the meta-model service 202 or in physical asset repositories 204. For example, if topic 90 was a model asset that existed in model assets 212, topic 90 would be associated with another topic 91 which may be an industry vertical meta model 140. Topic 90 may have occurrences in databases accessible through a uniform resource identifier (URI) 117, shown by the dashed lines. Other topic 92 may have occurrences in document models 216 accessible through URIs 118. By using topic maps as a meta-model internal to the physical asset repositories 204, a web service may programmatically access, manage, and maintain SOA IMR component 102.

Meta-Model Service 202 of SOA IMR component 102 is an SOA IMR meta-model service using topic map meta-model 210, which is an ISO/IEC Standard (ISO 13250-1) topic map meta model. Topic maps map both web and real-world information resources by reifying real-world resources as “subjects” and creating “topic” constructs to capture their characteristics and relationships with other topics and subjects. By using topic maps as a meta-model internal to the physical asset repositories 204, a common interface to Meta-Model Service 202 allows users to programmatically access, manage, and maintain these meta models.

Some of the advantages of using a topic map based meta model for SOA IMR component 102 are that the topic maps are independent of the implementation and are reusable for other service consumers. Topic maps can map to multiple occurrences and each model can be stored in different locations as different types of physical occurrences. Furthermore, Meta-Model Service 202 provides and supports full read and write capabilities abstract and instance ontology about an industry model.

SOA IMR component 102 has the capability of managing multiple domains. Each domain has its own meta-model and its own instance ontology. A topic map meta-model is created by SOA IMR component 102 through SOA IMR program 67.

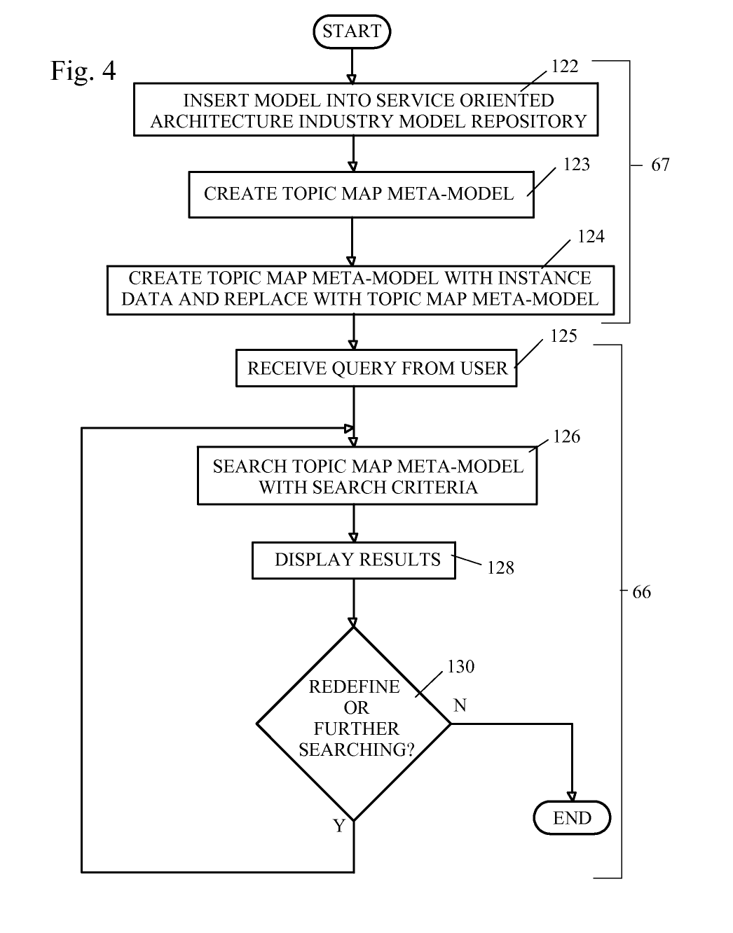

FIG. 4 shows a flowchart of a method of creating and searching a topic map meta-model with instance ontology. SOA IMR program 67 inserts a model, for example a canonical model or abstract model 205, into SOA IMR component 102 (step 122), and SOA IMR program 67 creates a topic map meta-model 210 (step 123) based on meta-meta-meta model 206 with a topic map index and meta-meta model 208 using IMR common ontology. After SOA IMR program 67 creates topic map meta-model 210 (step 123), SOA IMR program 67 creates a topic map meta-model with associated instance ontology and replaces topic map meta-model 210 created in step 123 (step 124). SOA IMR program 67 can create the topic map meta-model with associated instance ontology by creating a topic map indexing of abstract model 205 and instance ontology 207. Instance ontology 207 may be part of a particular domain or scope. For example, if a topic map meta-model has a topic of city operations, the instance ontology of the topic map meta-model could be, for example, in the scope of water or in the scope of traffic. Search model program 66 receives a search query containing search criteria (step 125). Search model program 66 can receive the search query from a user interface. The interface may be topic map interface 104 or another interface. The search query preferably includes at least one domain, at least one a topic, at least one scope and a radix.

For example, the query can have the following syntax:

/search/<<domain>>/<<topic>>/<<scope>>/<<radix>>

A user may input the query into topic map interface 104. Topic map interface 104 may be a representational state transfer (REST) based interface, although other interfaces may be used. A REST interface is preferably used since REST is a standards-based Internet protocol and is self documenting in terms of how to do the search, for example which domain to search, which topic to search, and how much of the topic map meta-model should be returned as a result of the search.

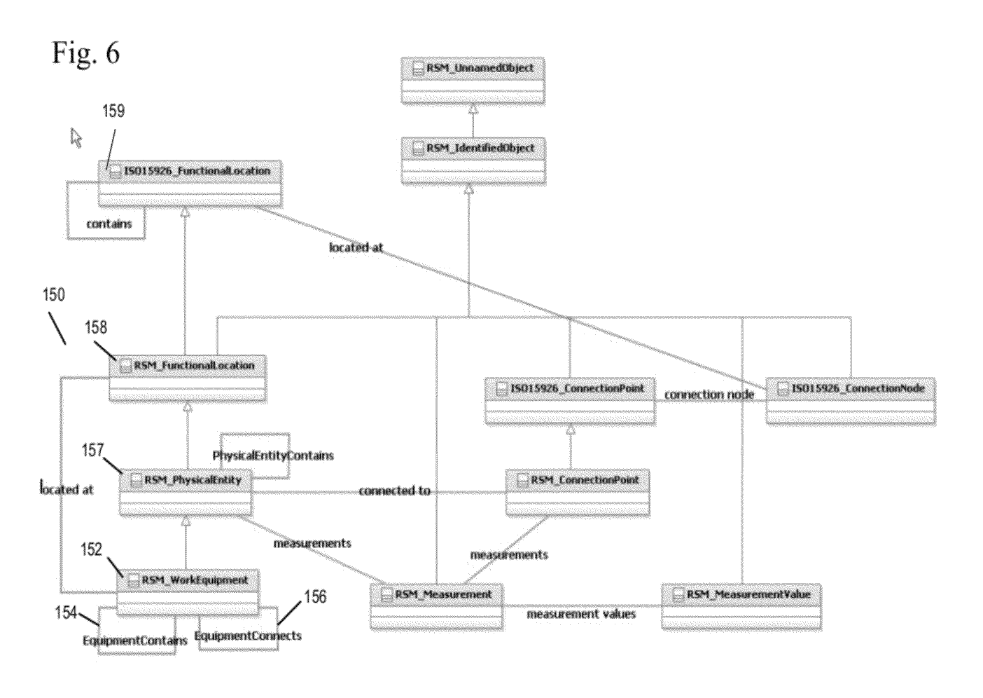

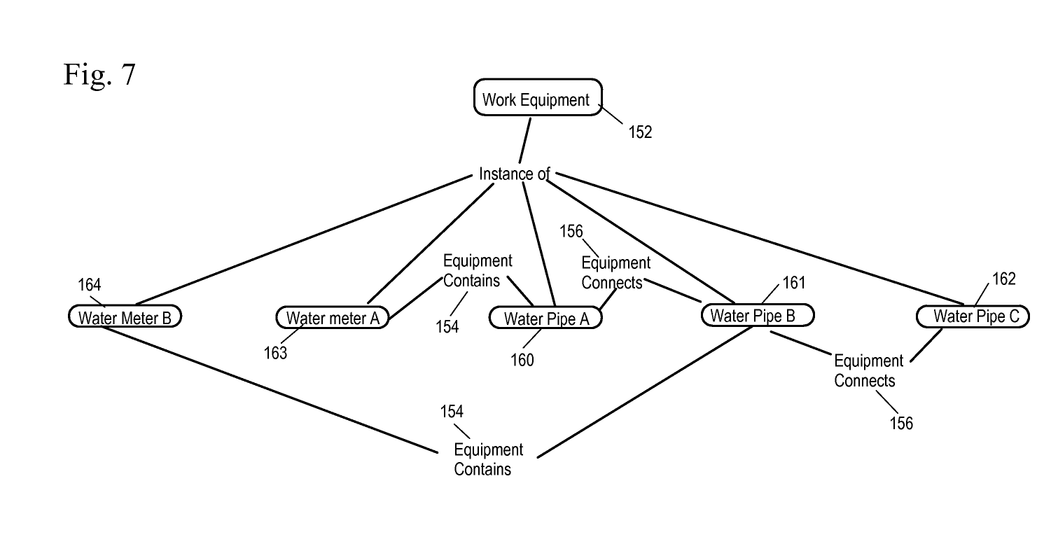

The domain of the query is the overall relevant system to be searched, e.g., a city. The topic of the query is the name of an asset relevant to the search, for example, in a City Operation setting, a water domain or a traffic domain. The scope of the query is a subset of the domain, for example, a particular time range. The radix of the query is the number of degrees from the search topic to be returned. For example, a radix of 1 would display results directly connected to the topic. A radix of 2 would display results of everything directly connected to the topic and directly connected to the matters directly connected to the topic. Foe example, in searching in a water topic for a particular pipe with a setting of a radix to 1, the results of the query would display everything connected to the pipe. If the radix setting was 2, the results of the query would display everything connected to the pipe and everything connected to components connected to the pipe under radix 1. This is discussed in greater detail in the description referring to FIGS. 6 and 7.

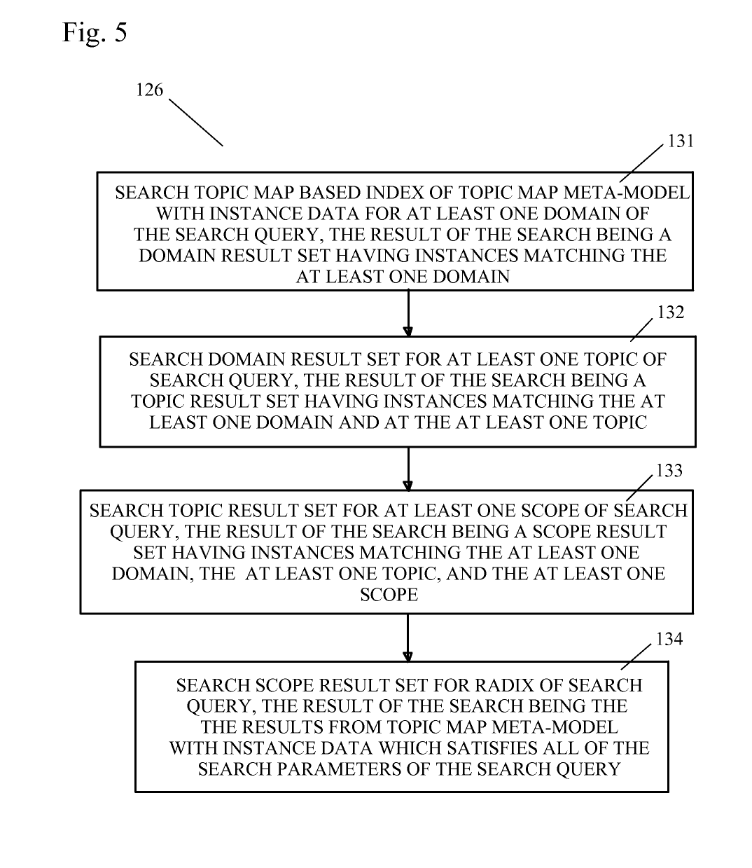

Search model program 66 searches a topic map index of the topic map meta-model with associated instance ontology using the search query (step 126). Search model program 66 can search for at least one domain, at least one topic, at least one scope and a radix of the search query in an iterative fashion as shown in FIG. 5. Alternatively, search model program 66 can search for at least one domain, at least one topic, at least one scope and a radix of the search model query simultaneously within the topic map index of the topic map meta-model with instance ontology.

Search model program 66 returns the results of the search of the topic map meta-model with instance ontology and displays the results (step 128). Search model program 66 may display the results on interface 104. Search model program 66 may display the results as a mathematical topic map as shown in Tables 1, 2, and 3 below, a topic map graph as shown in FIG. 8, or other formats specified by the user, such as a Topic Map compliant result set compliant with Topic Map XML Schema Standard (http://www.isotopicmaps.org/sam/sam-xtm/). Rendering engines or other programs may transform the results into a graph for the user. Furthermore, the data results may be displayed in other formats than those presented within the application, for example in topic map graph format and other easy to comprehend formats. In one embodiment, search model program 66 can display intersections of the search results.

If search model program 66 receives input from a user that further searching or redefining of the search is necessary, search model program 66 returns to step 126 of searching the topic map meta-model with instance ontology. If search model program 66 receives input from the user that no further searching or redefining of the search is required, the method ends. This method of searching allows a user with domain expertise, but not significant IT skills, to explore and comprehend a model of a domain with instance ontology in which the user works, removing a requirement for the user to learn and comprehend complex query languages such as SPARQL.

FIG. 5 shows a flowchart of a method for searching a topic map meta-model with instance ontology with a search query. Steps 131 through 137 are an example implementation of step 126 of FIG. 4.

In step 131, search model program 66 searches the topic map based index of the topic map meta-model with instance ontology for at least one domain of the search query, the result of the search being a domain result set having instances matching the at least one domain. Search model program 66 then searches the domain result set for at least one topic of the search query, the result of the search being a topic result set having instances matching the at least one domain and the at least one topic (step 132). Search model program 66 then searches the topic result set for at least one scope of the search query, the result of the search being a scope result set having instances matching the at least one domain and the at least one topic and the at least one scope (step 133). Then, search model program 66 searches the scope result set for a radix of the search query (step 134), the result of the search being a portion of the topic map meta-model with instance ontology that satisfies all of the search parameters of the search query.

FIG. 6 shows an exemplary abstract model for work equipment used by city operations. Abstract model 150 is an example of abstract model 205 and may be in model assets 212, associated with meta-model service interface 202, and inserted into IMR 102 at step 122 of FIG. 4. Abstract model 150 is shown in FIG. 6 as a Rational Software Modeler (RSM) model as might be used for work equipment used by city operations. For this example, the discussion will focus on a portion of abstract model 150 shown. A work equipment type (RSM_WorkEquipment) 152 can contain other pieces of work equipment (EquipmentContains) 154 (e.g. a pipe can contain a water meter reader to measure the flow of water through the pipe) and can also be connected to other pieces of work equipment (EquipmentConnects) 156 (e.g. a pipe can be connected to other pipes). Work equipment type 152 is a physical entity (RSM_PhysicalEntity) 157 located at a functional location (RSM_FunctionalLocation) 158 (e.g. a pipe can be located in particular part of a city) and is identified with a functional location (ISO15926_FunctionalLocation) 159.

FIG. 7 shows an example of a topic map meta-model created at step 124 of FIG. 4. In particular, FIG. 7 shows a topic map meta-model with instance ontology of abstract model 150, in particular, RSM_WorkEquipment 152 as shown in FIG. 6. WorkEquipment type 152 has an instance of water pipe A 160, water pipe B 161, water pipe C 162, water meter A 163, and water meter B 164. EquipmentContains 154 water pipe A 160 and water meter A 163 and water pipe B 161 and water meter B 164. Water pipe A 160 connects (shown by EquipmentConnects 156) to Water pipe B 161. Water pipe B 161 connects (shown by EquipmentConnects 156) to water pipe C 162.

A user may submit the following search query to search model program 66 via topic map interface 104 to search the topic map with associated instance data of FIG. 7:

/search/domain/water/topic/pipeA/scope/2009/radix/1.

The query is an example of a query that search model program 66 can receive at step 125 of FIG. 4. In this search query, water is the domain, water pipe A is the topic, the year 2009 is the scope, and 1 is the radix.

FIG. 8 shows an example of search results displayed to a user based on a search query of the topic map meta-model with instance ontology of FIG. 7. The search results are an example of the search results that search model program 66 can display at step 128 of FIG. 4. The results show everything in the “water” domain of a particular city that is directly connected to water pipe A constrained by a date of 2009 and includes the equipment in which is connected to water pipe A, the type of equipment connected to water pipe A, and any equipment that is contained within water pipe A. The date of 2009 may include the year the equipment was installed, last maintained, or any other event for water pipe A that took place in 2009. Including temporal scope in topic map meta-models is described in greater detail in an application entitled “TEMPORAL SCOPE TRANSLATION OF META-MODELS USING SEMANTIC WEB TECHNOLOGIES”, filed Feb. 1, 2011 as application Ser. No. 13/018,909.

As shown in FIG. 8, WorkEquipment type 152 has an instance of water pipe A 160, water pipe B 161, and water meter A 163. Water pipe A 160 is directly connected, (shown by EquipmentConnects 156) to water pipe B 161 and contains (shown by EquipmentContains 154) water meter A 163. If the search query had a radix of 2 instead of 1, search model program 66 would generate results showing that water pipe B 161 connects (EquipmentConnects 156) to water pipe C 162 and water pipe B 161 contains (EquipmentContains 154) water meter B 164.

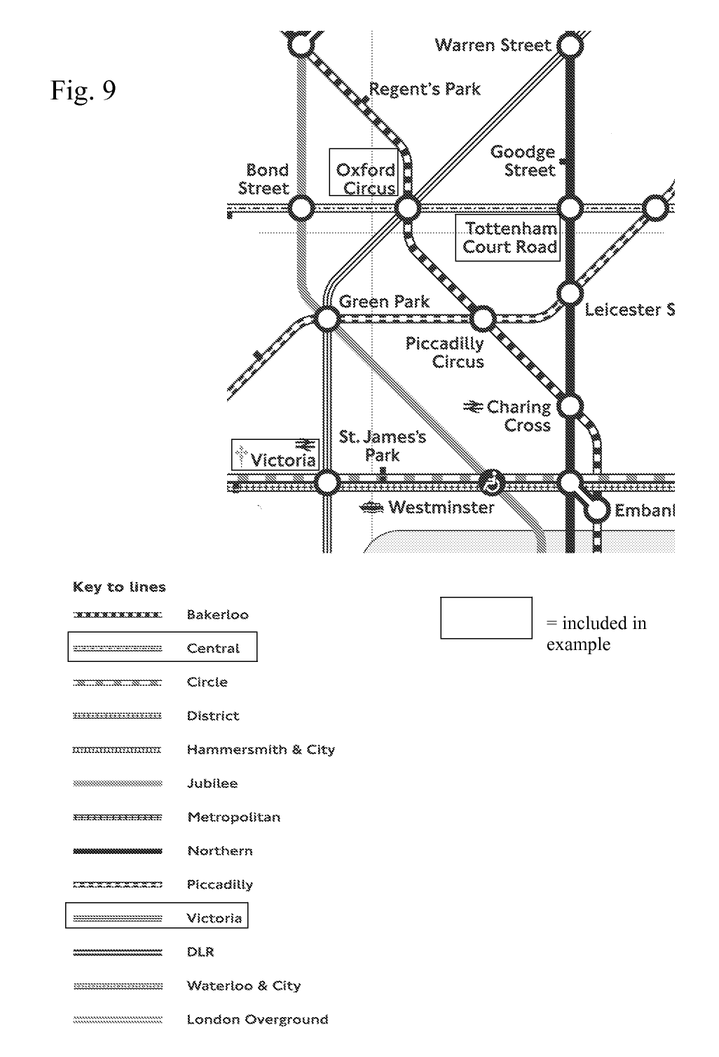

FIG. 9 shows a topic map meta-model with instance ontology of a portion of the London Underground system. For this example it should be understood that the London Underground map is a topic map meta-model with instance ontology of the meta-model London Underground. For example, nodes on the map represent tube stations, and the lines connecting the nodes represent the London Underground rail infrastructure. In the example of the London Underground, topics may be, for example, Victoria and Oxford Circus, with the occurrences being the physical station locations, and the associations being the connections between the stations. The associations within a topic map all have association types and association roles. The association roles are made up of the topic and the role that the topic plays in the association. So, in terms of the London Underground example and the connection between Victoria and Green Park, the association type is London Underground connection, Victoria plays a role in this association, and the role Victoria plays is that of a tube station. Similarly, Green Park plays a role in this association and the role Green Park plays is that of a tube station.

An association can also contain scope. Scope can be thought of in terms of mathematical sets and by expressing context relevant information in terms of scope. The topic maps can be subset down to reflect a specified context, for example a tourist.

In a first example of search model program 66 performing steps 125 through 128 of FIG. 4 using the London Underground topic map meta-model with instance ontology, a user may submit the following query to search model program 66 via interface 104. The query is an example of a query that search model program 66 can receive in step 125 of FIG. 4. It should be noted that, for this example, the only tube stations connected to the Victoria Line are Victoria and Oxford Circus.

### Search Query:

http://topicmap.dydns.ws/xml/topicMapService/domain/test/topic/Victoria/scope/London_Underground/radix/1

In this search query, the domain is test, the topic is “Victoria” and the scope is “London Underground”. The radix is 1, so search model program 66 would refine the search results to return everything directly connected to the topic of “Victoria”. Search model program 66 can display the results at step 128 of FIG. 4 as the mathematical topic map would display results as shown in Table 1 below.

TABLE 1

```
−<topicMap>
    +<topic id =“Victoria_Line”></topic>
    +<topic id =“Tube_Line”></topic>
    +<topic id =“Tube_Station”></topic>
    +<topic id =“Oxford_Circus”></topic>
    +<topic id =“Victoria”></topic>
    −<association reifier=101”>
      −<type>
        <topicRef href=“Tube_Line”/>
      −</type>
      −<scope>
        <topicRef href=“Victoria_Line”/>
        <topicRef href=“London_Underground”/>
      </scope>
      −<role>
        −<type>
          <topicRef href=“Tube_Station”/>
        </type>
        <topicRef href=“Oxford_Circus”/>
      </role>
      −<role>
        −<type>
          <topicRef href=“Tube_Station”/>
        </type>
        <topicRef href=“Oxford_Circus”/>
      </role>
      −<role.
        −<type>
          <topicRef href=“Tube_Station”/>
        </type>
        <topicRef href=“Victoria”/>
      </role>
    </association>
  </topicMap>
```

As shown in Table 1, search model program 66 returns, search results including the following relationships. The topic of “Victoria” is a “Victoria Line” (a specific train line within the London Underground) and a “Victoria tube station” in the domain of the “Underground”. The “Victoria Line” has a number of stations—in this example, the “Victoria Tube Station” and the “Oxford Circus Tube Station”. “Oxford Circus” and “Victoria Station” are connected to each other only on the “Victoria Line”.

In a second example of search model program 66 performing steps 125 through 128 of FIG. 4 using the London Underground topic map meta-model with instance ontology, a user may submit the following query to search model program 66 via interface 104. The query is an example of a query that search model program 66 can receive in step 125 of FIG. 4. It should be noted that for this example, only the Victoria tube station and the Oxford Circus tube station are connected to the Victoria Line, and only the Oxford Circus tube station and the Tottenham Court Road tube station are connected on the Central Line.

### Search Query:

http://topicmap.dyndns.ws/xml/topicMapService/domain/test/topic/Victoria/scope/London_Underground/radix/2

In this search query, the domain is test, the topic is “Victoria” and the scope is “London Underground”. The radix is 2, so search model program 66 would refine the search results to return everything directly connected to the topic of “Victoria”, and everything directly connected to everything directly connected to the topic of “Victoria.” Search model program 66 can display the results at step 128 of FIG. 4 as the mathematical topic map shown in Table 2 below.

TABLE 2

```
−<topicMap>
  +<topic id =“London_Underground”></topic>
  +<topic id =“TCR”></topic>
  +<topic id =“Tube_Line”></topic>
  +<topic id =“Tube_Station”></topic>
  +<topic id =“Oxford_Circus”></topic>
  +<topic id =“Victoria”></topic>
  −<association reifier=102”>
    −<type>
      <topicRef href=“Tube_Line”/>
    −</type>
    −<scope>
      <topicRef href=“Central_Line”/>
      <topicRef href=“London_Underground”/>
    </scope>
    −<role>
      −<type>
        <topicRef href=“Tube_Station”/>
      −</type>
      <topicRef href=“TCR”/>
    </role>
    −<role>
      −<type>
        <topicRef href=“Tube_Station”/>
      </type>
      <topicRef href=“Oxford_Circus”/>
    </role>
    </association>
    −<association reifier=“101”>
      −<type>
        <topicRef href=“Tube_Line”/>
      </type>
      −<scope>
        <topicRef href=“Victoria_Line”/>
        <topicRef href=London_Underground”/>
      </scope>
      −<role>
        −<type>
          −<topicRef href=“Tube_Station”/>
        </type>
        <topicRef href=“Victoria”/>
      </role>
  </association>
</topicMap>
```

As shown in Table 2, search model program 66 returns search results including the following associations based on the Victoria tube station being connected to the Oxford Circus by the Victoria Line, and the Oxford Circus tube station being connected to the Tottenham Court Road tube station by the Central Line. In association “102”, “Central Line” is a tube line connection between “TCR” or Tottenham Court Road tube station and “Oxford Circus” tube station, and this association is in the scope of the “London Underground” and the “Central Line” tube line. In association “101”, “Victoria” is a tube line connection between the “Victoria” tube station and the “Oxford Circus” tube station, and the association is in the scope of the “London Underground” and the “Victoria” tube line.

In a third example of search model program 66 performing steps 125 through 128 of FIG. 4 using the London Underground topic map meta-model with instance ontology, a user may submit the following query to search model program 66 via interface 104. The query is an example of a query that the search model program 66 can receive in step 125 of FIG. 4. It should be noted that for this example, only the Victoria tube station and the Oxford Circus tube station are connected to the Victoria Line.

### Search Query:

http://topicmap.dyndns.ws/xml/topicMapService/domain/test/topic/Victoria/scope/Victoria_Line/radix/1

In this search query, the domain is test, the topic is “Victoria” and the scope is “Victoria Line”. The radix is 1, so search model program 66 would refine the search results to return everything directly connected to the topic of “Victoria”. Search model program 66 can display the results at step 128 of FIG. 4 as the mathematical topic map shown in Table 3 below.

TABLE 3

```
−<topicMap>
  +<topic id =“Victoria_Line”></topic>
  +<topic id =“Tube_Line”></topic>
  +<topic id =“Tube_Station”></topic>
  +<topic id =“Oxford_Circus”></topic>
  +<topic id =“Victoria”></topic>
  −<association reifier=101”>
    −<type>
      <topicRef href=“Tube_Line”/>
    −</type>
    −<scope>
      <topicRef href=“Vicoria_Line”/>
      <topicRef href=“London_Underground”/>
    </scope>
    −<role>
      −<type>
        <topicRef href=“Tube_Station”/>
      </type>
      <topicRef href=“Oxford_Circus”/>
    </role>
    −<role>
      −<type>
        <topicRef href=“Tube_Station”/>
      </type>
      <topicRef href=“Victoria”/>
      </role>
  </association>
</topicMap>
```

As shown in Table 3, the search model program 66 returns search results including the following relationships. The topic of “Victoria” is a tube line and is part of the “London Underground”. “Victoria” is also a tube station directly connected to “Oxford Circus” tube station on the Victoria tube line.

It should be noted that the searches and results will often contain significantly greater amounts of data that may need to be further refined and searched.

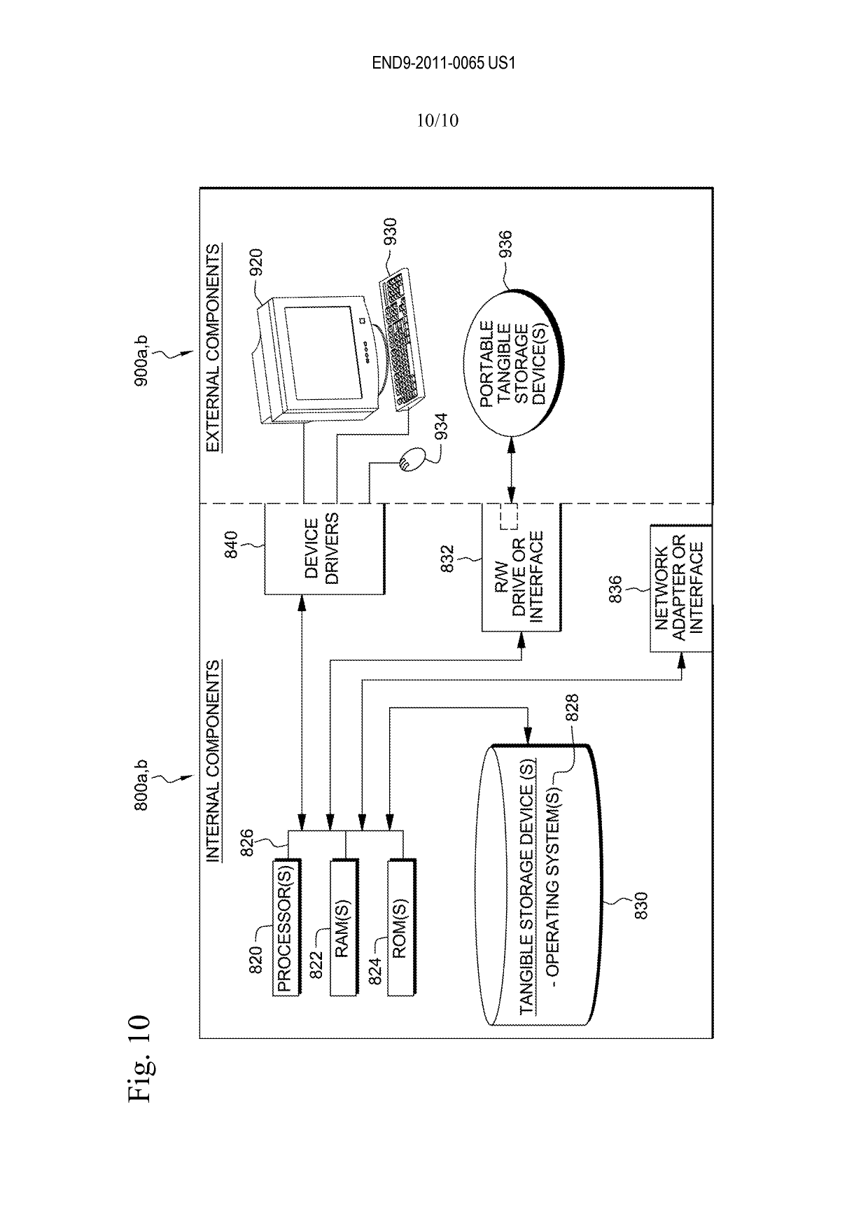

FIG. 10 illustrates internal and external components of client computer 52 and server computer 54 in which illustrative embodiments may be implemented. In FIG. 10, client computer 52 and server computer 54 include respective sets of internal components 800a, 800b, and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and search model programs 66 are stored on one or more of the computer-readable tangible storage devices 830 for execution by one or more of the processors 820 via one or more of the RAMs 822 (which typically include cache memory). In the embodiment illustrated in FIG. 10, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. Search model program 66 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. Search model program 66 and SOA IMR program 67 can be downloaded to computer 52 and server computer 54 from an external computer via a network (for example, the Internet, a local area network or other, wide area network) and network adapter or interface 836. From the network adapter or interface 836, search model program 66 and SOA IMR program 67 are loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 940. Each of the sets of internal components 800a, 800b also includes device drivers 840 to interface to computer display monitor 920, keyboard 930 and computer mouse 940. The device drivers 840, R/W drive or interface 832 and network adapter or interface 836 comprise hardware and software (stored in storage device 830 and/or ROM 824).

Search model program 66 and SOA IMR program 67 can be written in various programming languages including low-level, high-level, object-oriented or non object-oriented languages. Alternatively, the functions of search model program 66 can be implemented in whole or in part by computer circuits and other hardware (not shown).

Based on the foregoing, a computer system, method and program product have been disclosed for searching within topic maps of a model for canonical model based integration. However, numerous modifications and substitutions can be made without deviating from the scope of the present invention. Therefore, the present invention has been disclosed by way of example and not limitation.

What is claimed is:

1. A method of searching within a topic map based index of a topic map meta-model with instance ontology, the method comprising the steps of:
a computer receiving a search query from a user, the search query comprising a domain, a topic, a scope, and a radix;
a computer searching the topic map based index of the topic map meta-model with instance ontology using as search parameters the domain, the topic, the scope, and the radix of the search query; and
the computer displaying results from the topic map meta-model with instance ontology which satisfy all of the search parameters of the search query.

2. The method of claim 1, further comprising the steps of:
the computer inserting a model into an service oriented architecture industry model repository;
the computer creating the topic map meta-model;
the computer creating a topic map meta-model with instance ontology; and
before the step of the computer receiving the search query from the user, the computer replacing the topic map meta-model with the topic map meta-model with instance ontology.

3. The method of claim 1, wherein the step of the computer displaying the results from the topic map meta-model which satisfy all of the search parameters of the search query comprises the step of the computer displaying the results in a topic map format.

4. The method of claim 1, wherein the step of the computer displaying the results from the topic map meta-model which satisfy all of the search parameters of the search query comprises the step of the computer displaying the results in an XML format.

5. The method of claim 1, wherein the scope of the search query is temporal scope.

6. The method of claim 1, wherein the step of the computer searching the topic map based index of the topic map meta-model with instance ontology using as the search parameters the domain, the topic, the scope, and the radix of the search query further comprises the steps of:
the computer searching the topic map based index of the topic map meta-model with instance ontology for the domain of the search query;
the computer generating a domain result set having instances matching the domain;
the computer searching the domain result set for the topic of the search query;
the computer generating a topic result set having instances matching the domain and the topic;
the computer searching the topic result set for the scope of the search query;
the computer generating a scope result set having instances matching the domain and the topic and the scope; and
the computer searching the scope result set for a radix of the search query.

7. The method of claim 1, wherein:
the step of the searching the topic map based index of the topic map meta-model with instance ontology using the domain, the topic, the scope, and the radix of the search query further comprises the step of the computer searching for the domain, the topic, the scope, and the radix of the search query simultaneously within the topic map based index, and
the step of the computer displaying the results from the topic map meta-model with instance ontology which satisfy all of the search parameters of the search query comprises the computer displaying those instances from the topic map meta-model which satisfy all of the search parameters of the search query.

8. A computer program product comprising one or more computer-readable, tangible storage devices and computer-readable program instructions which are stored on the one or more storage devices and when executed by one or more processors, perform the method of claim 1.

9. A computer program product for searching within a topic map meta-model with instance ontology, the computer program product comprising:
one or more computer-readable tangible storage devices;
program instructions, stored on at least one of the one or more storage devices, to receive a search query from a user, the search query comprising a domain, a topic, a scope, and a radix;
program instructions, stored on at least one of the one or more storage devices, to search the topic map based index of the topic map meta-model with instance ontology using as search parameters the domain, the topic, the scope, and the radix of the search query; and
program instructions, stored on at least one of the one or more storage devices, to display results from the topic map meta-model with instance ontology which satisfy all of the search parameters of the search query.

10. The computer program product of claim 9, further comprising:
program instructions, stored on at least one of the one or more storage devices, to insert a model into a service oriented architecture industry model repository;
program instructions, stored on at least one of the one or more storage devices, to create the topic map meta-model;
program instructions, stored on at least one of the one or more storage devices, to create a topic map meta-model with instance ontology; and
program instructions, stored on at least one of the one or more storage devices, to replace the topic map meta-model with the topic map meta-model with instance ontology before receiving the search query from the user.

11. The computer program product of claim 9, wherein the program instructions to display the results from the topic map meta-model with instance ontology which satisfy all search parameters of the search query display the results in a topic map format.

12. The computer program product of claim 9, wherein the program instructions to display the results form the topic map meta-model with instance ontology which satisfy all search parameters of the search query display the results in an XML format.

13. The computer program product of claim 9, wherein the scope of the search query is temporal scope.

14. The computer program product of claim 9, wherein the program instructions to search the topic map based index of the topic map meta-model with instance ontology using as the search parameters the domain, the topic, the scope, and the radix of the search query:
search the topic map based index of the topic map meta-model with instance ontology for the domain of the search query,
generate a domain result set having instances matching the domain;
search the domain result set for the topic of the search query,
generate a topic result set having instances matching the domain and the topic;
search the topic result set for the scope of the search query,
generate a scope result set having instances matching the domain and the topic and the scope; and
search the scope result set for the radix of the search query.

15. The computer program product of claim 9, wherein:
the program instructions to search the topic map based index of the topic map meta-model with instance ontology using as the search parameters the domain, the topic, the scope, and the radix of the search query search for the domain, the topic, the scope, and the radix of the search query simultaneously within the topic map based index; and
the program instructions to display results from the topic map meta-model with instance ontology which satisfy all of the search parameters of the search query display those instances from the topic map meta-model which satisfy all of the search parameters of the search query.

16. A computer system for searching within a topic map meta-model with instance ontology, the computer system comprising:
one or more computer-readable tangible storage devices, one or more processors, and one or more computer-readable memories;
program instructions, stored on at least one of the one or more storage devices for execution by at least one of the one or more processors via at least one of the one or more memories, to receive a search query from a user, the search query comprising a domain, a topic, a scope, and a radix;
program instructions, stored on at least one of the one or more storage devices for execution by at least one of the one or more processors via at least one of the one or more memories, to search the topic map based index of the topic map meta-model with instance ontology using as search parameters the domain, the topic, the scope, and the radix of the search query; and
program instructions, stored on at least one of the one or more storage devices for execution by at least one of the one or more processors via at least one of the one or more memories, to display results from the topic map meta-model with instance ontology which satisfy all of the search parameters of the search query.

17. The computer system of claim 16, comprising:
program instructions, stored on at least one of the one or more storage devices for execution by at least one of the one or more processors via at least one of the one or more memories, to insert a model into a service oriented architecture industry model repository,
program instructions, stored on at least one of the one or more storage devices for execution by at least one of the one or more processors via at least one of the one or more memories, to create the topic map meta-model;
program instructions, stored on at least one of the one or more storage devices for execution by at least one of the one or more processors via at least one of the one or more memories, to create a topic map meta-model with instance ontology;
program instructions, stored on at least one of the one or more storage devices for execution by at least one of the one or more processors via at least one of the one or more memories, to replace the topic map meta-model with topic map meta-model with instance ontology before receiving the search query from the user.

18. The computer system of claim 16, wherein the program instructions to display the results from the topic map meta-model which satisfy all search parameters of the search query display the results in a topic map format.

19. The computer system of claim 16, wherein the program instructions to display the results from the topic map meta-model which satisfy all search parameters of the search query display the results in an XML format.

20. The computer system of claim 16, wherein the scope of the search query is temporal scope.

21. The computer system of claim 16, wherein the program instructions to search the topic map based index of the topic map meta-model with instance ontology using as the search parameters the domain, the topic, the scope, and the radix of the search query:
search the topic map based index of the topic map meta-model with instance ontology for the domain of the search query;
generate a domain results set having instances matching the domain;
search the domain result set for the topic of the search query;
generate a topic result set having instances matching the domain and the topic;
search the topic result set for the scope of the search query;
generate a scope result set having instances matching the domain and the topic and the scope; and
search the scope result set for the radix of the search query.

22. The computer system of claim 16, wherein:
the program instructions to search the topic map based index of the topic map meta-model with instance ontology using as the search parameters the domain, the topic, the scope, and the radix of the search query search for the domain, the topic, the scope, and the radix of the search query simultaneously within the topic map based index; and
the program instructions to display results from the topic map meta-model with instance ontology which satisfy all of the search parameters of the search query display those instances from the topic map meta-model which satisfy all of the search parameters of the search query.
